(19) United States
(12) Patent Application Publication
(10) Pub. No.: US 2016/0108982 A1
(43) Pub. Date: Apr. 21, 2016

(54) FRICTION MATERIAL AND FRICTION MATERIAL FOR USE IN DRUM BRAKE

(71) Applicant: OTSUKA CHEMICAL CO., LTD., Osaka (JP)

(72) Inventors: Takuya Nomoto, Tokushima-city (JP); Emiko Daimon, Tokushima-city (JP)

(73) Assignee: OTSUKA CHEMICAL CO., LTD., Osaka-city, Osaka (JP)

(21) Appl. No.: 14/889,566

(22) PCT Filed: May 7, 2014
(86) PCT No.: PCT/JP2014/062225

§ 371 Date: Nov. 6, 2015

(30) Foreign Application Priority Data
May 15, 2013 (JP) 2013-103169

(51) Int. Cl. F16D 69/02; F16D 65/22

(52) U.S. Cl. CPC F16D 69/026; F16D 65/22; F16D 2200/0043; F16D 2200/0065

(57) ABSTRACT

Provided is a friction material and a friction material for a drum brake which have an excellent fade characteristic and excellent wear resistance. A friction material contains a titanate compound and a binder, wherein the titanate compound is contained in 1 to 22% of the total volume of the friction material and the binder is contained in 18% or more of the total volume of the friction material.

### TECHNICAL FIELD

This invention relates to friction materials and friction materials for drum brakes.

### BACKGROUND ART

Friction materials for use in brake systems for various vehicles, industrial machines, and so on are required to have excellent wear resistance and a high and stable friction coefficient. To meet these characteristics, friction materials are used in which a friction modifier, a lubricant, and a filler are used together with a binder resin (binder) for binding the above additives.

Continuous use of a brake causes its friction material to rise to high temperatures, so that the friction coefficient may be extremely reduced (a fade phenomenon). Among brake systems, a drum brake has a closed structure and therefore has problems of poor heat radiation performance and ease of occurrence of a fade phenomenon. The fade phenomenon is believed to occur on the grounds that an organic component in the friction material is decomposed to generate a gas and the gas intervenes between the friction material and the drum.

Patent Literature 1 discloses that a fade phenomenon can be reduced by blending iron oxide or potassium titanate having an average particle size of 3.5 μm or more, but does not propose any measures for reducing a fade phenomenon in a friction material in which a large amount of binder is blended. The friction material for the drum brake has an arcuate shape and is therefore required to have a large amount of binder blended therein for the purpose of maintaining the strength thereof.

The drum brake produces a force toward being drawn into the drum by pressing a brake shoe having a friction material called a lining applied thereon against the inside of the rotating drum, so that it can produce a braking force greater than the force input thereto (a self-servo effect). Larger coefficients of friction of the friction material provide greater self-servo effects. However, if the friction coefficient varies owing to the environment of usage, the variations are amplified by the self-servo effect, which makes it difficult to accurately control the braking force.

### CITATION LIST

### Patent Literature

Patent Literature 1: JP-A-2011-236332

### SUMMARY OF INVENTION

### Technical Problem

An object of the present invention is to provide a friction material and a friction material for a drum brake which have an excellent fade characteristic and excellent wear resistance.

### Solution to Problem

The present invention provides the following friction material and friction material for a drum brake.

Aspect 1: A friction material containing a titanate compound and a binder, wherein the titanate compound is contained in 1 to 22% of the total volume of the friction material and the binder is contained in 18% or more of the total volume of the friction material.

Aspect 2: The friction material according to aspect 1, being a friction material for a drum brake.

Aspect 3: The friction material according to aspect 1 or 2, wherein a volume ratio of the titanate compound to the binder is 0.1:1 to 1:1.

Aspect 4: The friction material according to any one of aspects 1 to 3, further containing inorganic fibers.

Aspect 5: The friction material according to any one of aspects 1 to 4, wherein the binder is a phenolic resin.

Aspect 6: The friction material according to any one of aspects 1 to 5, wherein the titanate compound has an alkaline elution rate of 15% by mass or less.

### Advantageous Effects of Invention

The friction material and friction material for a drum brake of the present invention have an excellent fade characteristic and excellent wear resistance.

### DESCRIPTION OF EMBODIMENTS

Hereinafter, a description will be given of an example of a preferred embodiment for working of the present invention. However, the following embodiment is simply illustrative. The present invention is not at all intended to be limited to the following embodiment.

A friction material of the present invention contains a titanate compound and a binder, wherein the titanate compound is contained in 1 to 22% of the total volume of the friction material and the binder is contained in 18% or more of the total volume of the friction material.

The content of the titanate compound need be 1 to 22% of the total volume of the friction material, but it is preferably 2 to 15% by volume and more preferably 2 to 10% by volume. If the content of the titanate compound is larger than 22% by volume, this causes a anti-fade phenomenon where the friction coefficient increases, which is undesirable. The anti-fade phenomenon is assumed to occur because an organic component decomposes to increase the amount of inorganic component exposed on the friction surface. If the content of the titanate compound is smaller than 1% by volume, sufficient wear resistance cannot be achieved, which is undesirable.

The alkaline elution rate of the titanate compound need be 15% by mass or less, but it is preferably 0.1 to 15% by mass, more preferably 0.1 to 10% by mass, and still more preferably 0.1 to 6% by mass. The use of such a titanate compound can reduce the fade phenomenon to improve the wear resistance. The reason for this can be assumed to be that an alkaline component produced by wear failure of the titanate compound acts to generate a decomposed gas of the organic component or a transfer film.

The titanate compound used in the present invention preferably has an aqueous dispersion pH of 7 to 11, more preferably 8 to 10, and still more preferably 9 to 10. When the aqueous dispersion pH of the titanate compound is in the above range, the friction properties can be prevented from being deteriorated owing to acidic impurities contained in the titanate compound.

The term alkaline elution rate used in the present invention refers to the percentage by mass of any alkali metal and alkaline earth metal eluted from the titanate compound in water at 80° C. into the water. The alkaline elution rate can be measured with, for example, an ion chromatograph. The term aqueous dispersion pH used in the present invention refers to the pH of a slurry obtained by dispersing a titanate compound into water at 20° C.

The titanate compound used in the present invention is preferably a salt of at least one element selected from the group consisting of alkali metals and alkaline earth metals. Alkali metals include lithium, sodium, potassium, rubidium, cesium, and francium and preferred alkali metals are lithium, sodium, and potassium. Alkaline earth metals include beryllium, magnesium, calcium, strontium, barium, and radium and preferred alkaline earth metals are magnesium and calcium.

Examples of the titanate compound include alkali metal titanates represented by a general formula M₂O.nTiO₂ (where M is one or more of alkali metals and n is a number of 4 to 11), alkaline earth metal titanates represented by a general formula RO.TiO₂ (where R is one or more of alkaline earth metals), titanate compounds represented by a general formula MₓA_{y}Ti_{2-y}O₄ (where M is an alkali metal other than lithium, A is one or more selected from lithium, magnesium, zinc, nickel, copper, iron, aluminum, gallium, and manganese, x is a number of 0.5 to 1.0, and y is a number of 0.25 to 1.0), lepidocrocite-type lithium potassium titanates represented by a general formula K_{0.5-0.8}Li_{0.27}Ti_{1.73}O_{3.85-4}, and lepidocrocite-type magnesium potassium titanates represented by a general formula K_{0.2-0.8}Mg_{0.4}Ti_{1.6}O_{3.7-4} Preferred among them are titanate compounds whose crystal structure is a tunnel structure and specific examples thereof include Na₂Ti₆O₁₃, Na₂Ti₈O₁₇, K₂Ti₆O₁₃, K₂Ti₈O₁₇, Li₄Ti₅O₁₂, CaTiO₃, and MgTiO₃. The tunnel structure can reduce the alkaline elution from the titanate compound.

Possible forms of the titanate compound include fibrous particles and non-fibrous particles, such as spherical, lamellar, platy, prismoidal, blocky, and irregular particles, and non-fibrous forms are preferred from the viewpoint of improving the working environment and the friction and wear properties. The average particle size is preferably 0.1 to 50 μm, more preferably 1 to 50 μm, and still more preferably 1 to 20 μm. The term average particle size used in the present invention means the particle diameter at 50% cumulative volume in a particle size distribution as determined by the laser diffraction and scattering method.

The binder used in the present invention can be an arbitrary one appropriately selected from among known binders for use in friction materials. Examples that can be cited include thermosetting resins, such as phenolic resins, formaldehyde resins, melamine resins, epoxy resins, acrylic resins, aromatic polyester resins, and urea resins. One of them can be used alone or two or more of them can be used in combination. Preferred among them are phenolic resins.

The amount of the binder blended need be 18% or more of the total volume of the friction material, but it is preferably 19% by volume or more and more preferably 20% by volume or more. The upper limit of the amount of binder blended is preferably 40% by volume, more preferably 30% by volume, and still more preferably 25%. If the amount of binder blended is small, sufficient wear resistance cannot be achieved, which is undesirable. The volume ratio of the titanate compound to the binder is preferably 0.1:1 to 1:1, more preferably 0.1 to 0.7, and still more preferably 0.1 to 0.5. Such a compounding ratio can reduce the fade phenomenon to improve the wear resistance.

The friction material of the present invention preferably further contains inorganic fibers. The amount of the inorganic fibers blended is preferably 1 to 20% of the total volume of the friction material and more preferably 5 to 15% by volume. In the present invention, the combination of the inorganic fibers and the titanate compound acts to further improve the fade characteristic and the wear resistance. The average fiber diameter of the inorganic fibers is preferably 0.1 to 10 μm and the average fiber length thereof is preferably 100 to 800 μm.

The type of inorganic fiber used in the present invention can be an arbitrary one appropriately selected from among known types of inorganic fiber for use in friction materials. Examples that can be cited include rock wool, wollastonite fiber, AlO₃—SiO₂-based ceramic fiber, biosoluble ceramic fiber, glass fiber, and carbon fiber. One of them can be used alone or two or more of them can be used in combination. Preferred among them is rock wool.

Additives or the like which are commonly used heretofore as friction modifiers for friction materials may be blended alone or in any combination of two or more thereof into the friction material of the present invention without losing desired physical properties of the friction material. Examples of such friction modifiers that can be cited include an abrasive material, a lubricant, organic dust, metal, and a filler. These modifiers can be blended according to friction properties required for a product, such as friction coefficient, wear resistance, vibration characteristics, and squeal characteristics.

In producing the friction material of the present invention, the above binder and titanate compound are blended, if necessary, together with inorganic fibers, a friction modifier, and so on, the mixture is formed into a shape at a predetermined pressure and normal temperature, then thermoformed at a predetermined temperature, and then subjected to thermal treatment and finishing, so that a formed body of a friction material can be produced.

The friction material of the present invention can be used for disc brakes, drum brakes, and so on. The friction material can be used particularly suitably for drum brakes since their variations in friction coefficient are amplified by the self-servo effect and they are therefore likely to cause a fade phenomenon. Specific examples that can be cited as drum brakes include a leading/trailing brake, a two-leading brake, a duo two-leading brake, and a duo-servo brake.

### Examples

The present invention will be described below in further detail with reference to specific examples. The present invention is not at all limited by the following examples and modifications and variations may be appropriately made therein without changing the gist of the invention.

The following titanate compounds were used in Examples and Comparative Examples. The alkaline elution rate and the aqueous dispersion pH were measured according to the following methods.

(Titanate Compound A)

Composition: potassium octatitanate (composition formula K₂O.8TiO₂), particle form: platy, average particle size: 8 μm, alkaline elution rate: 0.2% by mass, and aqueous dispersion pH: 9.4

(Titanate Compound B)

Composition: magnesium potassium titanate (composition formula K_{0.7}Mg_{0.4}Ti_{1.6}O_{3.95}), particle form: platy, average particle size: 4 μm, alkaline elution rate: 5.3% by mass, and aqueous dispersion pH: 11

(Titanate Compound C)

Composition: potassium hexatitanate (composition formula K₂O.6TiO₂), particle form: platy, average particle size: 27 μm, alkaline elution rate: 0.2% by mass, and aqueous dispersion pH: 9.2

(Titanate Compound D)

Composition: potassium hexatitanate (composition formula K₂O.6TiO₂), particle form: prismoidal, average length: 2.0 μm, average diameter: 0.4 μm, alkaline elution rate: 0.2% by mass, and aqueous dispersion pH: 9.5

(Titanate Compound E)

Composition: potassium hexatitanate (composition formula K₂O.6TiO₂), particle form: fibrous, average length: 13 μm, average diameter: 0.4 μm, alkaline elution rate: 0.1% by mass, and aqueous dispersion pH: 7.0

(Method for Measuring Alkaline Elution Rate)

The mass (x) of a titanate compound was measured, the titanate compound was then added to distilled water to prepare a 1% by mass slurry, the slurry was stirred at 80° C. for four hours, and a solid was then removed from the slurry with a membrane filter having a pore size of 0.2 μm to obtain an extraction liquid. The total mass (Y) of alkali metal and alkaline earth metal in the obtained extraction liquid was measured with an ion chromatograph (ICS-1100 manufactured by Dionex Corporation). Then, the alkaline elution rate was calculated based on the formula [ (Y)/(X)]×100 using the masses (X) and (Y).

(Method for Measuring Aqueous Dispersion pH)

An amount of 1 g of a titanate compound was added to 100 mL of distilled water to prepare a 1% by mass slurry and the pH of the obtained slurry (at 20° C.) was measured with a pH meter (F21 manufactured by Horiba, Ltd.) to calculate an aqueous dispersion pH.

### Production of Friction Material

### Examples 1 to 8 and Comparative Examples 1 and 2

Various materials were blended in each of the compositions shown in Table 1 and mixed with a Lodige mixer, and the obtained mixture was preliminarily formed (at 10 MPa), thermoformed (at 150° C. and 20 MPa), and further subjected to a thermal treatment (at 210° C.) to produce a friction material. The friction material was processed into a sectorial test piece having an area of 5.5 cm² and the obtained test piece was subjected to a friction test.

The friction test was conducted using a scale dynamometer in conformity with JASO C406:2000, wherein a 110-mm diameter piece of cast iron (carbon content: 3.3%) was used as the rotor and the inertia was set to be an absorption energy of 1200 J/cm² (at an initial velocity of 100 km/h) per unit area of a friction material for a drum brake for a 2-t to 25-t truck). The friction coefficient during a 2^{nd} fade test was measured. The initial friction coefficient, the minimum friction coefficient, and the fade rate were shown in Table 1. The fade rate was calculated based on the formula [(minimum friction coefficient)/(friction coefficient just before dropping)]×100, but the fade rate in Comparative Example 2 where a anti-fade phenomenon appeared was calculated based on the formula [(final friction coefficient)/(initial friction coefficient)]×100. The 2^{nd} fade test was conducted at an initial velocity of 100 km/h and a deceleration of 0.5 G, wherein the number of braking times was thirty. Furthermore, the friction material (test piece) and the rotor after the completion of the friction test were measured in terms of the wear amount and the results are shown in Table 1.

In Table 1, “Rock wool” is rock wool having a fiber length of 125 μm (RB295-Roxul 1000 manufactured by Lapinus Fibres) and “Phenolic resin” is a novolac phenolic resin (PR-51510 manufactured by Sumitomo Bakelite Co., Ltd.).

TABLE 1

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| Composition | Phenolic resin (% by volume) | 22 | 22 | 22 | 22 | 22 | 22 | 22 | 22 | 22 | 22 |
| | Aramid fiber (% by volume) | 10 | 10 | 10 | 10 | 10 | 10 | 10 | 10 | 10 | 10 |
| | Cashew dust (% by volume) | 13 | 13 | 13 | 13 | 13 | 13 | 13 | 13 | 13 | 13 |
| | Barium sulfate (% by volume) | 43 | 40 | 35 | 40 | 40 | 40 | 40 | 50 | 45 | 22 |
| | Rock wool (% by volume) | 10 | 10 | 10 | 10 | 10 | 10 | 10 | | 10 | 10 |
| | Titanate compound A (% by volume) | 2 | 5 | 10 | | | | | 5 | | 23 |
| | Titanate compound B (% by volume) | | | | 5 | | | | | | |
| | Titanate compound C (% by volume) | | | | | 5 | | | | | |
| | Titanate compound D (% by volume) | | | | | | 5 | | | | |
| | Titanate compound E (% by volume) | | | | | | | 5 | | | |
| Friction Test | Initial friction coefficient | 0.48 | 0.46 | 0.44 | 0.45 | 0.49 | 0.47 | 0.46 | 0.45 | 0.47 | 0.33 |
| | Minimum friction coefficient | 0.44 | 0.42 | 0.41 | 0.40 | 0.43 | 0.42 | 0.43 | 0.41 | 0.35 | 0.41 |
| | Fade rate (%) | 92 | 91 | 93 | 89 | 88 | 89 | 93 | 91 | 74 | 124 |
| | Wear amount of friction material (μm) | 140 | 118 | 108 | 115 | 136 | 129 | 126 | 190 | 182 | 104 |
| | Wear amount of rotor (mg) | 0.1 | 0.1 | 0.1 | 0.0 | 0.2 | 0.1 | 0.1 | 0.0 | 0.1 | 0.0 |

As shown in Table 1, friction materials in Examples 1 to 8 according to the present invention have an excellent fade characteristic and excellent wear resistance as compared to the friction material in Comparative Example 1. It can be seen that the friction material in Comparative Example 2 containing a larger amount of titanate compound than the range defined by the present invention exhibited a high fade rate and therefore deteriorated the fade characteristic. Furthermore, a comparison between Example 2 and Example 8 shows that the inclusion of rock wool, which is inorganic fibers, further improves the wear resistance.

1. A friction material containing a titanate compound and a binder, wherein the titanate compound is contained in 1 to 22% of the total volume of the friction material and the binder is contained in 18% or more of the total volume of the friction material.

2. The friction material according to claim 1, being a friction material for a drum brake.

3. The friction material according to claim 1, wherein a volume ratio of the titanate compound to the binder is 0.1:1 to 1:1.

4. The friction material according to claim 1, further containing inorganic fibers.

5. The friction material according to claim 1, wherein the binder is a phenolic resin.

6. The friction material according to claim 1, wherein the titanate compound has an alkaline elution rate of 15% by mass or less.
